(19) United States
(12) Patent Application Publication
(10) Pub. No.: US 2008/0270471 A1
(43) Pub. Date: Oct. 30, 2008

(54) Apparatus and method for internet service provider filtering in web analytics reports

(75) Inventor: Michael Schon, San Rafael, CA (US)

Correspondence Address: REED SMITH, LLP, TWO EMBARCADERO CENTER, SUITE 2000, SAN FRANCISCO, CA, 94111, US

(73) Assignee: LeadLander, Inc.

(21) Appl. No.: 11/789,379

(22) Filed: Apr. 24, 2007

(51) Int. Cl. G06F 17/30

(52) U.S. Cl. 707/104.1; 707/E17.032

(57) ABSTRACT

A method and apparatus for filtering ISP names, related to visitors to a website, from web analytics reports. Filtering terms related to names of Internet Service Providers (ISPs) are stored, and a visitor name associated with an Internet Protocol (IP) address of a website visitor is determined by, for example, use of a WHOIS database. The visitor name of a website visitor is compared with the filtering terms, and if the visitor name matches a filtering term, the visitor name is marked as an ISP entity.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates generally to World Wide Web analytics software, and more particularly to a method and apparatus for filtering irrelevant ISP information in web analytics software.

2. Description of the Related Art

Internet web sites run on web servers, and web servers can passively gather data about each visitor viewing pages on a web site by observing and logging the data exchanged between the web server and a visitor.

Web analytics is the process of tracking, collecting and reporting web site visitation data. Web analytics software may be provided either as stand-alone software run by a user, or may be provided as, for example, an online service, such as via an application service provider (ASP) type service. Web analytics software and services are typically designed to benefit a marketing department's objectives: i.e. counting the number of unique IP addresses that visit a website; counting the number of times a particular page on the site is viewed; tracking traffic patterns by time of day; and identifying the types of web browsers used by the website visitors.

Furthermore, web analytics software and services can identify the IP address of each visitor, and can also determine the name of the organization or person that corresponds to each IP address. However, results from web analytics software often contain irrelevant information for sales people. Sales people generally want customer-specific information, such as the name of the person, or the person's employer, who is visiting a website. Too often, web analytics software and services can only identify an IP address as an Internet Service Provider ISP such as “America Online”™ or “Earthlink”™ and not as a specific company or person. Web analytics software and services include this information in their reports, and the sales personnel do not obtain any benefits from seeing a listing of visitors identified only by their ISPs in the reports. The inclusion of such irrelevant information also makes it more difficult to focus on the more relevant information.

Thus, it would be desirable for web analytics software and services to provide a report that eliminates such irrelevant information.

### SUMMARY OF THE INVENTION

In general, the present invention is a method and apparatus for filtering ISP name information from web analytics reports. In one embodiment, the present invention includes a method for filtering information about visitors to websites, the method comprising storing filtering terms related to names of Internet Service Providers (ISPs); determining a visitor name associated with an Internet Protocol (IP) address of a website visitor; comparing the visitor name of a website visitor with the filtering terms; and marking the visitor name as an ISP if the visitor name matches a filtering term.

In one embodiment, the storing of filtering terms may comprise storing words, phrases or names associated with common Internet Service Providers in a database. Determining a visitor name may comprise using a database of domain name registrant information, such as a WHOIS database, and determining a name associated with the IP address of the website visitor. The method may further comprise generating a report excluding the names marked as an ISP from a listing of website visitors. Or, alternatively, the method may further comprise generating a report excluding the names not marked as an ISP from a listing of website visitors.

The present invention may also be embodied in a computer readable media. A computer readable media according to the present invention includes computer executable code for execution on one or more processors, the computer readable media comprising: computer code for determining a visitor name associated with an Internet Protocol (IP) address of a website visitor; computer code for comparing the visitor name of a website visitor with a list of filtering terms; and computer code for marking the visitor name as an ISP if the visitor name matches a filtering term.

The computer readable media may further comprise computer code for storing a list of filtering terms related to names of Internet Service Providers (ISPs). The list of filtering terms may comprise words, phrases or names associated with common Internet Service Providers in a database. The computer code for determining a visitor name may comprise computer code for using a database of domain name registrant information and determining a name associated with the IP address of the website visitor.

Additionally, the computer readable media may further comprise computer code for generating a report excluding the names marked as an ISP from a listing of website visitors; or may further comprise computer code for generating a report excluding the names not marked as an ISP from a listing of website visitors. The computer readable media may also include computer code for generating a graphical user interface to display a list of names not marked as ISPs.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a flow chart of a preferred embodiment of the present invention;

FIG. 2 illustrates an example of an ISP filtering terms database;

FIG. 3 illustrates an example of a list of organizations, and associated IP addresses;

FIG. 4 is a screen-shot of a report query for generating a report filtering out the ISPs;

FIG. 5 illustrates a graphical user interface to generate a report that excludes ISPs from a displayed list;

FIG. 6 is a further illustration of a graphical user interface to generate a report that excludes ISPs from a displayed list;

FIG. 7 illustrates a graphical user interface that can be used to generate a report that only includes ISPs; and

FIG. 8 is a further illustration of a graphical user interface to generate a report that includes only ISPs from a displayed list.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

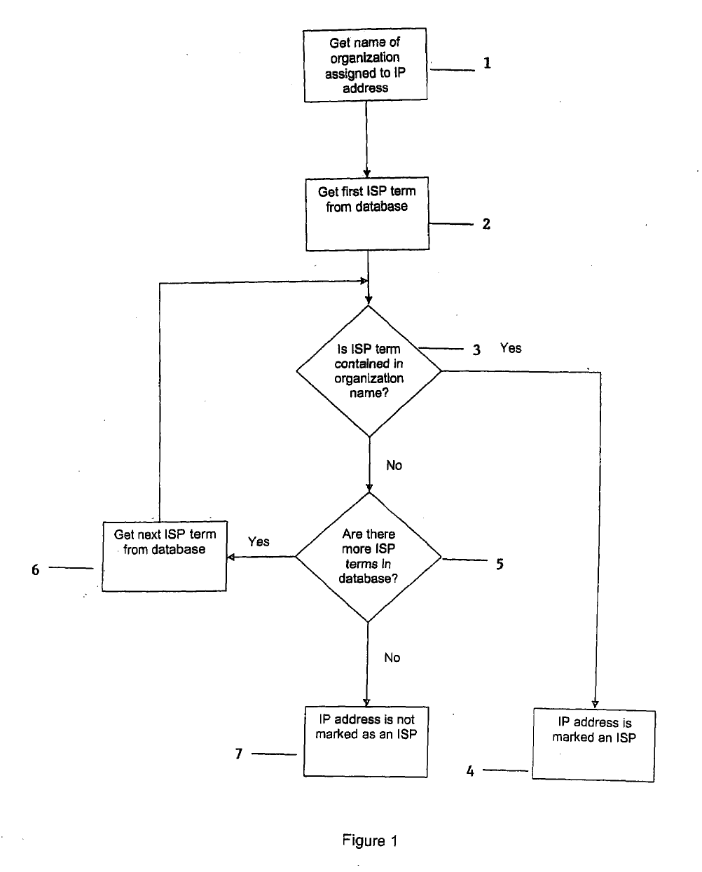

In general, the present invention provides a method and system for filtering out Internet Service Provider (“ISP”) information from web analytics reports. A flow chart one embodiment of the present invention is illustrated in FIG. 1. The processing of the present invention may be implemented in software using well known computer programming techniques.

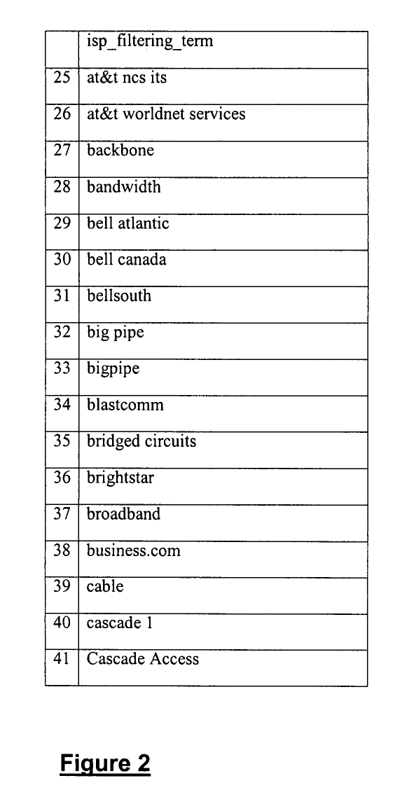

First, a list of known ISP and ISP-related terms is created and stored in a database. The database includes ISP filtering terms that are commonly used words, phrases, or names associated with common Internet Service Providers. A sample of ISP filtering terms is shown in FIG. 2. The ISP filtering terms can either be fractional names such as the word “online”, character strings such as “341.53” or a complete name such as “America Online”. Other examples of ISP filtering terms include “telecommunications”, “wireless”, “hosted”, “service provider”, “Earthlink”, Road Runner”, and “SBC Internet Services”.

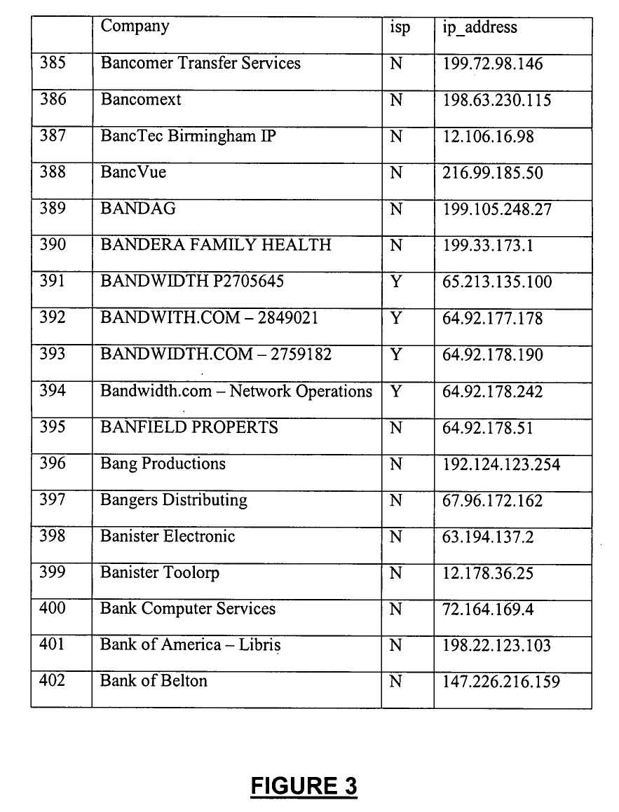

Each entry in a web analytics report is then processed. An organization's name that is assigned to each Internet Protocol (IP) address of a visitor is determined by comparing the IP address with information in a WHOIS database, or a database of information derived from a WHOIS database (step 1). A WHOIS database contains contact information about each domain name registrant, including the IP address. Examples of organization names with associated IP addresses are shown in FIG. 3.

Once the corresponding organization's name is obtained, the name is compared to each entry in the list of known ISPs and related terms that have been previously stored in the ISP filtering database (step 2). The program searches for any occurrence of an ISP filtering term within the organization's name (step 3). If the term is contained within the organization's name, the IP address entry is marked as an ISP and further comparison with the ISP filtering terms is stopped (step 4).

Otherwise, if there is no match, and there are more terms to search (step 5), the next ISP filtering term in the database is retrieved (step 6) is compared to the organization's name (step 3), and the process is repeated. If there are no more terms in the ISP filtering database (step 5), then the IP address is not marked as an ISP (step 7).

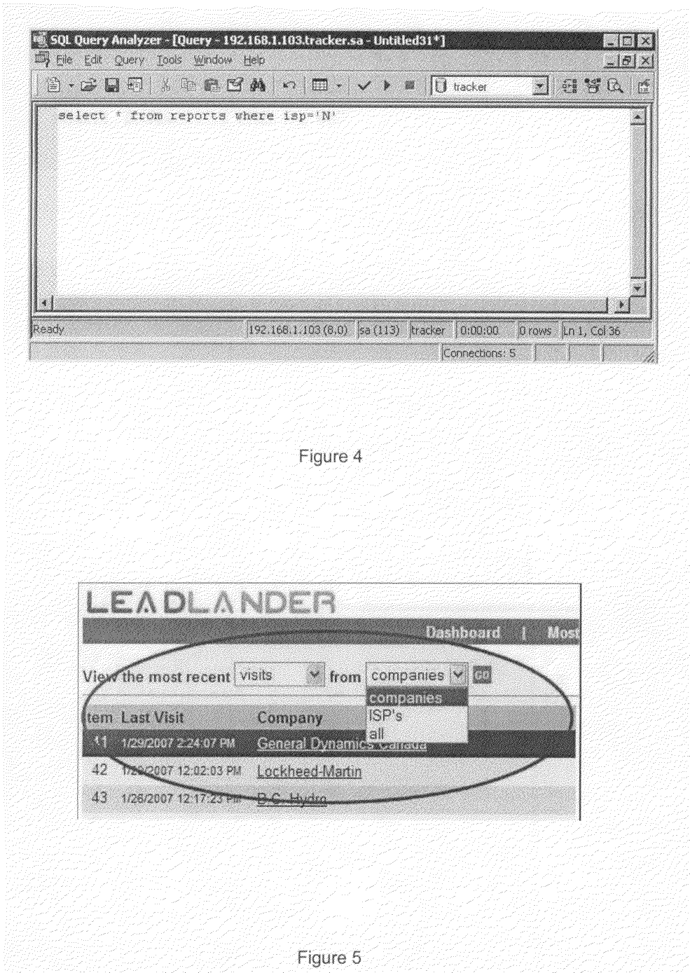

As a result of this ISP filtering processing, when a web analytics report is run either from a web analytics software program or a web analytics service, the entries marked as an ISP can be removed. For example, FIG. 4 shows a screen-shot of a report query in which the ISP filtering is enabled. This results in a cleaner, more readable and useful report for sales and marketing personnel.

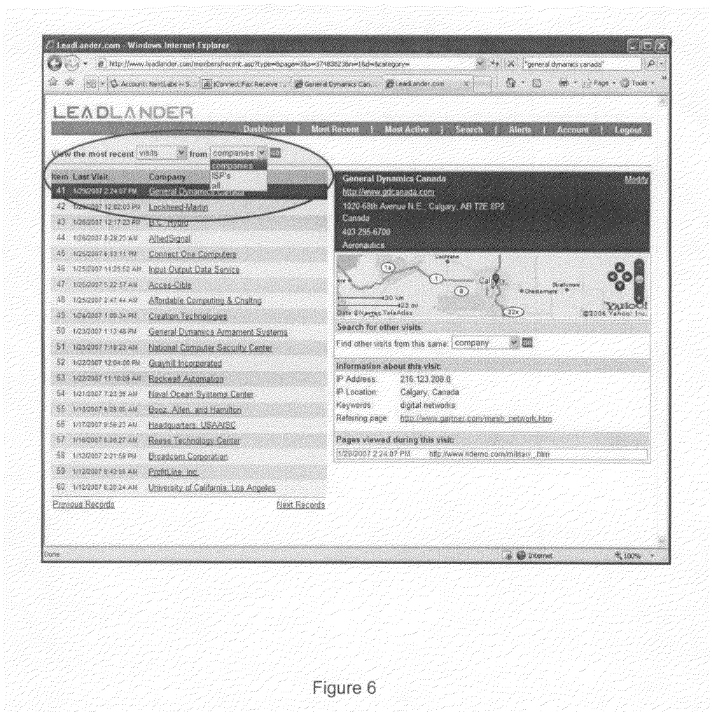

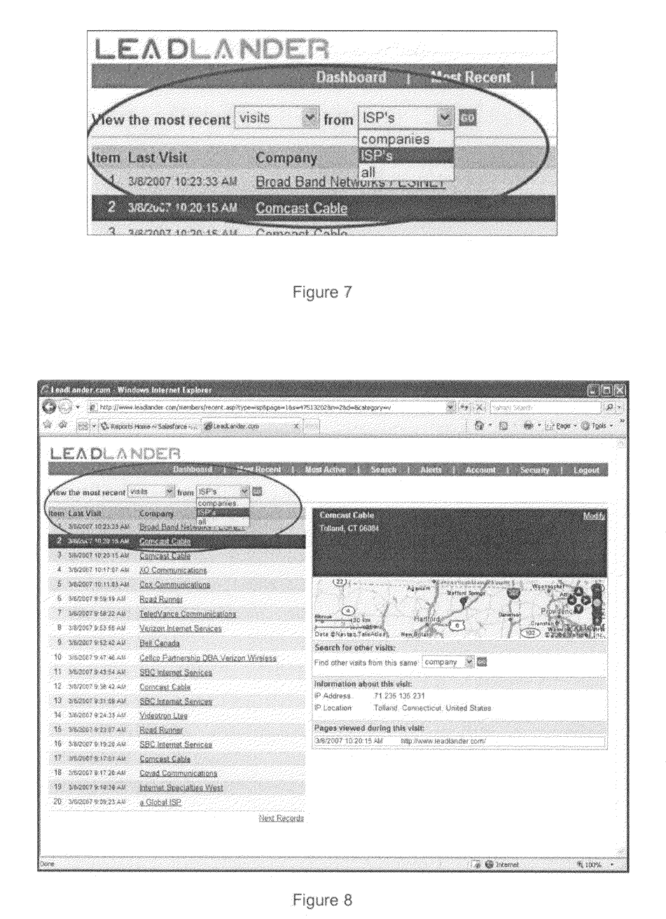

In addition, as illustrated in FIGS. 5 and 6, a graphical user interface can be used to generate reports that exclude ISPs from a displayed list of visitors. Similarly, FIGS. 7 and 8 illustrate a graphical user interface which can be used to generate reports which show only the entries that are marked as ISPs. This could be useful, for example, if the website has a promotion in connection with a particular ISP, the results can be used to determine the effectiveness of a promotion with a particular ISP.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CDRW±, micro-drive, and magneto-optical disks, ROMs, RAMs, EPROMs, EEPROMs, DRAMs, VRAMs, flash memory devices (including flash cards, memory sticks), magnetic or optical cards, MEMS, RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for filtering reports of information about visitors to websites, the method comprising:
storing filtering terms related to names of Internet Service Providers (ISPs);
determining a visitor name associated with an Internet Protocol (IP) address of a website visitor;
comparing the visitor name of a website visitor with the filtering terms; and
marking the visitor name as an ISP if the visitor name matches a filtering term.

2. The method of claim 1, wherein storing filtering terms comprises storing words, phrases or names associated with common Internet Service Providers in a database.

3. The method of claim 2, wherein determining a visitor name comprises using a database of domain name registrant information and determining a name associated with the IP address of the website visitor.

4. The method of claim 3, wherein the visitor name is the name of an organization associated with the IP address.

5. The method of claim 4, further comprising generating a report excluding the names marked as an ISP from a listing of website visitors.

6. The method of claim 4, further comprising generating a report excluding the names not marked as an ISP from a listing of website visitors.

7. A computer readable media including computer executable code for execution on one or more processors, the computer readable media comprising:
computer code for determining a visitor name associated with an Internet Protocol (IP) address of a website visitor;
computer code for comparing the visitor name of a website visitor with a list of filtering terms; and
computer code for marking the visitor name as an ISP if the visitor name matches a filtering term.

8. The computer readable media of claim 7, further comprising computer code for storing a list of filtering terms related to names of Internet Service Providers (ISPs).

9. The computer readable media of claim 8, wherein the list of filtering terms comprises words, phrases or names associated with common Internet Service Providers in a database.

10. The computer readable media of claim 7, wherein computer code for determining a visitor name comprises computer code for using a database of domain name registrant information and determining a name associated with the IP address of the website visitor.

11. The computer readable media of claim 10, wherein the visitor name is the name of an organization associated with the IP address.

12. The computer readable media of claim 11, further comprising computer code for generating a report excluding the names marked as an ISP from a listing of website visitors.

13. The computer readable media of claim 11, further comprising computer code for generating a report excluding the names not marked as an ISP from a listing of website visitors.

14. The computer readable media of claim 11, further comprising computer code for generating a graphical user interface to display a list of names not marked as ISPs.

15. The computer readable media of claim 11, further comprising computer code for generating a graphical user interface to display a list of names marked as ISPs.
